(19) United States
(12) Patent Application Publication
(10) Pub. No.: US 2008/0218651 A1
(43) Pub. Date: Sep. 11, 2008

(54) Electro-optical device and substrate for electro-optical device

(75) Inventors: Tomotoshi Kato, Hashima-shi (JP); Kengo Shiragami, Tottori-shi (JP); Shin Fujita, Suwa-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, AZUMINO-SHI (JP)

(21) Appl. No.: 12/068,808

(22) Filed: Feb. 12, 2008

(30) Foreign Application Priority Data
Mar. 9, 2007 (JP) 2007-059766

(51) Int. Cl. G02F 1/1343

(52) U.S. Cl. 349/39

(57) ABSTRACT

An electro-optical device includes: a holding capacitor provided in each pixel; a holding capacitance line connected to the holding capacitor; and an electric potential applying portion that applies an electric potential to the holding capacitance line. Both ends of the holding capacitance line are connected to the electric potential applying portion.

### BACKGROUND

1. Technical Field

The present invention relates to an electro-optical device and a substrate for an electro-optical device, and in particular, to an electro-optical device having a holding capacitance line and a substrate for an electro-optical device.

2. Related Art

In a TN (twisted nematic) mode liquid crystal display device, a method of applying an alternating current (AC) potential to a common electrode provided in a counter substrate is known. In addition, a driving method of applying a constant electric potential to a common electrode and applying an alternating current potential to a holding capacitance line is known. According to the latter driving method, the power consumption may be reduced.

Japanese Unexamined Patent Application Publication NO. 2002-196358 is an example of related art.

In general, holding capacitance lines and data lines intersect each other. For this reason, when the electric potential of the data line is changed due to coupling between the holding capacitance line and the data line, a noise is generated on the holding capacitance line. Furthermore, in the case of a driving method of applying an alternating current potential to the holding capacitance line, a load of the holding capacitance line and a wiring line used to apply an electric potential to the holding capacitance line is increased due to a large panel size, for example. If the load of the holding capacitance line and the like is increased, it becomes difficult to absorb the noise. As a result, the crosstalk may occur. The occurrence of the crosstalk will now be described.

Using a signal of a gate line as a trigger, an electric potential of a hold capacitance line is inverted after the electric potential of the gate line has changed from a high level to a low level. At this time, since a pixel transistor is turned off, the electric potential of a pixel electrode is in a floating state. As a result, the electric potential of the pixel electrode facing the holding capacitance line is changed due to coupling with the holding capacitance line. Assuming that an electric potential inverted on the holding capacitance line is V_{H}, the amount ΔV_{PX} of variation in electric potential of the pixel electrode is expressed by the following equation. In addition, C_{SC}, C_{LC}, and C_{PA} indicate a holding capacitance, a liquid crystal capacitance, and a parasitic capacitance of a pixel electrode, respectively.

ΔV_{PX}=C_{SC}/(C_{SC}+C_{LC}+C_{PA})×V_{H}

From the equation, it can be seen that the electric potential of the pixel electrode depends on the electric potential V_{H} inverted on the holding capacitance line. For this reason, it is necessary to stably perform application of an electric potential to the holding capacitance line.

However, in the case when a noise generated on the holding capacitance line is not absorbed as described above, the amount ΔV_{PX} varies with every display line, and as a result, the crosstalk occurs.

### SUMMARY

An advantage of some aspects of the invention is that it provides an electro-optical device capable of stably applying an electric potential to a holding capacitance line and a substrate for an electro-optical device.

According to an aspect of the invention, an electro-optical device includes: a holding capacitor provided in each pixel; a holding capacitance line connected to the holding capacitor; and an electric potential applying portion that applies an electric potential to the holding capacitance line. Both ends of the holding capacitance line are connected to the electric potential applying portion. According to the configuration described above, a load of the holding capacitance line is reduced. As a result, application of the electric potential to the holding capacitance line can be stably performed.

According to another aspect of the invention, an electro-optical device includes: a holding capacitor provided in each pixel; a holding capacitance line connected to the holding capacitor; and an electric potential applying portion that applies an electric potential to the holding capacitance line. The electric potential applying portion has a plurality of electric potential applying paths provided in a part thereof, the plurality of electric potential applying paths being connected in parallel to each other. According to the configuration described above, a resistance of the electric potential applying portion is reduced. As a result, the application of the electric potential to the holding capacitance line can be stably performed.

It is preferable that the plurality of electric potential applying paths include a path passing through a test pad. According to the configuration described above, the test pad can be effectively used. In addition, it is possible to suppress an increase in peripheral region.

Further, it is preferable that both the ends of the holding capacitance line be connected to the electric potential applying portion. According to the configuration described above, the load of the holding capacitance line is reduced. As a result, the application of the electric potential to the holding capacitance line can be stably performed.

According to still another aspect of the invention, a substrate for an electro-optical device includes: a holding capacitor provided in each pixel; a holding capacitance line connected to the holding capacitor; and an electric potential applying portion that applies an electric potential to the holding capacitance line. Both ends of the holding capacitance line are connected to the electric potential applying portion. According to the configuration described above, the load of the holding capacitance line is reduced. As a result, the application of the electric potential to the holding capacitance line can be stably performed.

According to still another aspect of the invention, a substrate for an electro-optical device includes: a holding capacitor provided in each pixel; a holding capacitance line connected to the holding capacitor; and an electric potential applying portion that applies an electric potential to the holding capacitance line. The electric potential applying portion has a plurality of electric potential applying paths provided in a part thereof, the plurality of electric potential applying paths being connected in parallel to each other. According to the configuration described above, a resistance of the electric potential applying portion is reduced. As a result, the application of the electric potential to the holding capacitance line can be stably performed.

In the electro-optical device according to the aspect of the invention, it is preferable to further include: a pixel electrode provided in each pixel; a pixel transistor connected to the pixel electrode; a gate line and a data line connected to the pixel transistor; and a driving circuit that outputs an electric potential applied to the gate line, the data line, and the electric potential applying portion. In addition, preferably, the driving circuit sequentially applies a high-level electric potential to the gate lines, applies an electric potential of display data to the data line during a period for which the gate line is in a high level to thereby apply the electric potential of the display data to the pixel electrode, and inverts the electric potential applied to the electric potential applying portion after the electric potential of the gate line has changed from a high level to a low level. According to the configuration described above, since noise resistance in each holding capacitance line is improved, a change in electric potential of a pixel electrode becomes equal in each display line. As a result, the crosstalk can be suppressed.

### BRIEF DESCRIPTION OF THE DRAWINGS

The invention will be described with reference to the accompanying drawings, wherein like numbers reference like elements.

FIG. 1 is a plan view schematically explaining a liquid crystal display device according to an embodiment.

FIG. 2 is a circuit diagram explaining the configuration of a display region in the embodiment.

FIG. 3 is a timing chart explaining a method of driving the liquid crystal display device according to the embodiment.

FIG. 4 is a plan view schematically explaining a second example of the liquid crystal display device according to the embodiment.

FIG. 5 is a plan view schematically explaining a third example of the liquid crystal display device according to the embodiment.

FIG. 6 is an enlarged plan view illustrating a portion surrounded by a dashed-dotted line shown in FIG. 5.

### DESCRIPTION OF EXEMPLARY EMBODIMENTS

Hereinafter, an embodiment of the invention will be described with reference to the accompanying drawings.

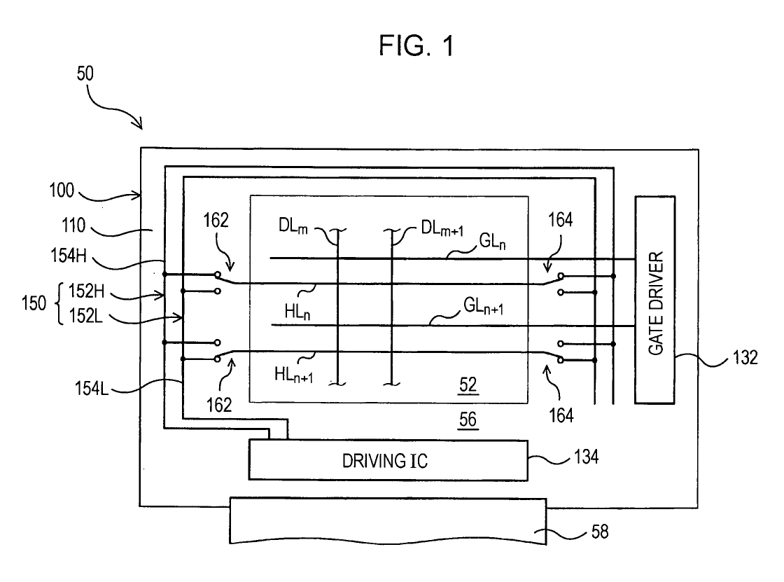

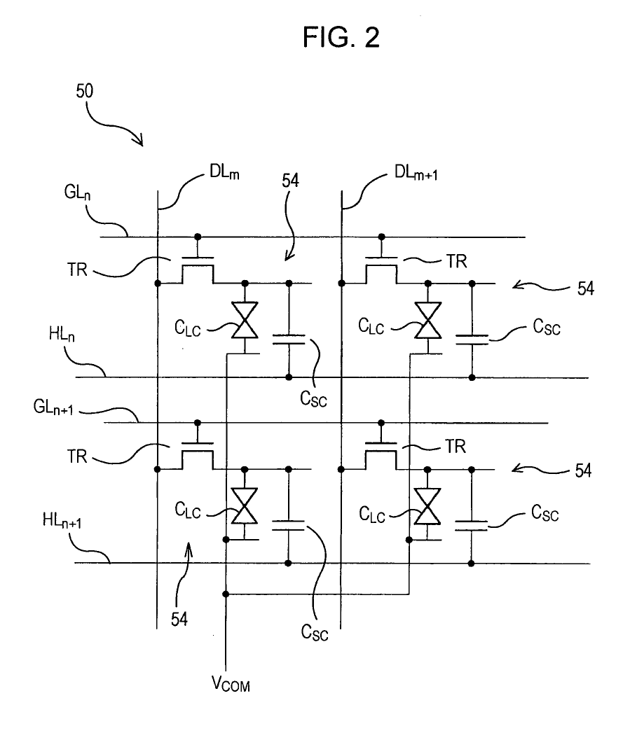

A plan view schematically explaining a liquid crystal display device 50 according to an embodiment is shown in FIG. 1, and a circuit diagram explaining the configuration of a display region 52 of the liquid crystal display device 50 is shown in FIG. 2. In FIG. 1, for example, a peripheral region 56 positioned outside the display region 52 is widely shown for the purpose of explanation. However, the actual dimension is not shown in the drawing.

The liquid crystal display device 50 includes a pair of substrates disposed opposite each other and a liquid crystal layer interposed between the pair of substrates. When the liquid crystal display device 50 is of a transmissive type or a transflective type, each of the substrates may be formed by using a transmissive substrate, such as a glass plate. When the liquid crystal display device 50 is of a reflective type, one of the pair of substrates may not be transmissive. The pair of two substrates are provided with various kinds of elements exemplified below, thereby forming an element substrate and a counter substrate, respectively. Accordingly, it can be said that a liquid crystal layer is interposed between the element substrate and the counter substrate. In addition, the counter substrate is not shown in FIG. 1. Hereinafter, a case in which the liquid crystal display device 50 is of a TN mode is illustrated.

First, the configuration of the display region 52 of the liquid crystal display device 50 will be described.

The liquid crystal display device 50 includes a gate line GL, a data line DL, a pixel transistor TR, a pixel electrode, a liquid crystal capacitor C_{LC}, a holding capacitance line HL, and a holding capacitor C_{SC}. In addition, as will be described later, the gate line is also called a pixel selection line, a scanning line, or the like and the data line is also called a drain line, a display signal line, or the like.

The gate line GL is provided in a substrate 110 that forms the element substrate 100 of the pair of substrates. The plurality of gate lines GL are provided in the entire liquid crystal display device 50, and only two adjacent (consecutive) gate lines GL are shown in FIGS. 1 and 2. In order to distinguish the two gate lines GL from each other, reference numerals GLₙ and GLₙ₊₁ (where ‘n’ is an integer) are used. Here, a case in which each of the gate lines GL extends in a row direction and the gate lines GL are arrayed in a column direction is illustrated.

The data line DL is provided in the substrate 110. The plurality of data lines DL are provided in the entire liquid crystal display device 50, and only two adjacent data lines DL are shown in FIGS. 1 and 2. In order to distinguish the two data lines DL from each other, reference numerals DLₘ and DLₘ₊₁(where ‘m’ is an integer) are used. Here, a case in which each of the data lines DL extends in a column direction and the data lines DL are arrayed in a row direction is illustrated.

That is, the data lines DL and the gate lines GL extend in the direction perpendicular to each other. Even though the lines GL and DL are shown in the shape of straight lines in the drawing, either the gate lines GL or the data lines DL or both of the gate lines GL and the data lines DL may have, for example, locally extending portions or zigzag portions, and as a whole, extend in the above-described directions.

The pixel transistor TR may be formed by using a thin film MOS (metal oxide semiconductor) transistor, for example. The pixel transistor TR is provided in the substrate 110. The pixel transistor TR is provided in each pixel 54 and is disposed near an intersection between the gate line GL and the data line DL in each pixel 54 (refer to FIG. 2). As shown in FIG. 2, each of the gate lines GL is connected to a gate of each of the plurality of pixel transistors TR arrayed in the row direction and each of the data lines DL is connected to a drain of each of the plurality of pixel transistors TR arrayed in the column direction. For this reason, the data line DL is also called the drain line DL. A source of each pixel transistor TR is connected to a pixel electrode provided in each pixel 54. The pixel electrode is provided in the substrate 110. Moreover, in the pixel transistor TR, the source and the drain may be called in the opposite order.

Using the configuration described above, an electric potential corresponding to display of the pixel 54 is applied from the data line DL to each pixel electrode through the pixel transistor TR. For this reason, the data line DL is also called the display line DL. The pixel 54 having a pixel electrode to which an electric potential is applied is selected by applying an ON potential of the pixel transistor TR to the gate line GL to which the pixel 54 is connected. For this reason, the gate line GL may also be called the pixel selection line GL. The plurality of gate lines GL are selected in a sequential manner, for example. In this case, the gate lines GL are also called scanning lines GL. In addition, a switching element other than the pixel transistor TR may also be used.

Here, a boundary between the pixels 54 may be set in a region between adjacent pixel electrodes, for example. In addition, for example, it is possible to make a region where a pixel electrode is disposed (or a range where a pixel electrode is disposed) correspond to a region of the pixel 54. Moreover, for example, it is also possible to make each opening of a light shielding layer, which will be described later, provided in a counter substrate correspond to a region of the pixel 54. The array of the pixels 54 may be any of a matrix array, a delta array, and the like.

The liquid crystal capacitor C_{LC} is provided in each pixel 54. The liquid crystal capacitor C_{LC} is formed by using a laminated structure in which a pixel electrode and a counter electrode, which is provided in the counter substrate and will be described later, are laminated with a liquid crystal layer interposed therebetween.

The holding capacitance line HL is provided in the substrate 110. The plurality of holding capacitance lines HL are provided in the entire liquid crystal display device 50. Here, a case in which each of holding capacitance lines HL extends in a row direction and the holding capacitance lines HL are arrayed in a column direction is illustrated. In this case, each holding capacitance line HL is provided over the plurality of pixels 54 arrayed in the row direction. Furthermore, a case in which the holding capacitance lines HL and the gate lines GL are alternately disposed is illustrated. Only two adjacent holding capacitance lines HL are shown in FIGS. 1 and 2. In order to distinguish the two holding capacitance lines HL from each other, reference numerals HLₙ and HLₙ₊₁ (where ‘n’ is an integer) are used. Even though the holding capacitance lines HL are shown in the shape of straight lines in the drawing, the holding capacitance lines HL may have, for example, locally extending portions or zigzag portions, and as a whole, extend in the above-described direction.

The holding capacitor C_{SC} is provided in each pixel 54 and is connected between the holding capacitance line HL and a source of the pixel transistor TR. Accordingly, the holding capacitor C_{SC} is connected with the liquid crystal capacitor C_{LC} through the source of the pixel transistor TR. For example, the holding capacitor C_{SC} may be formed by using a laminated structure in which the holding capacitance line HL and the pixel electrode are laminated with an insulating layer interposed therebetween. In addition, the holding capacitor C_{SC} may be formed by using a laminated structure in which the holding capacitance line HL and a semiconductor layer of the pixel transistor TR are laminated with an insulating layer interposed therebetween.

The liquid crystal display device 50 further includes a light shielding layer, a color filter, and a counter electrode. These elements are provided in a substrate that forms the counter substrate of the pair of substrates described above. The light shielding layer is disposed in at least a display region and an opening is provided at a position facing each pixel electrode. In each opening, a color filter having a color corresponding to a display color of the pixel 54 is disposed. Furthermore, for example, in the case of the liquid crystal display device 50 for black and white display, the color filter may not be provided. The counter electrode is disposed on the color filter, for example. The counter electrode is provided in each pixel 54. For example, the counter electrode may be formed by using a single conductive layer over all of the pixels 54. An electric potential VCOM (refer to FIG. 2) is applied to the counter electrode.

Hereinafter, the configuration of the peripheral region 56 of the liquid crystal display device 50 will be described.

The liquid crystal display device 50 includes a gate driver 132, a driving IC (integrated circuit) 134, and an electric potential applying portion 150 serving to apply an electric potential to the holding capacitance line HL, which are provided in the peripheral region 56. These elements are provided in the substrate 110.

The gate driver 132 is connected to all of the gate lines GL and applies the electric potential to the gate lines GL in a sequential manner, for example. The arrangement position of the gate driver 132 is not limited to the example shown in the drawing.

The driving IC 134 is a circuit that generates and outputs a voltage applied to the gate line GL, the data line DL, the holding capacitance line HL, and the like. The driving IC 134 is formed as an integrated circuit (IC). In FIG. 1, a case in which the driving IC 134 is provided between the display region 52 and an FPC (flexible printed circuit) 58 connected to the element substrate 100 is illustrated. In addition, details of connection between the driving IC 134 and the gate driver 132, the FPC 58, and the like are not shown in the drawing.

The electric potential applying portion 150 is connected to the driving IC 134 and all of the holding capacitance lines HL. Here, a case in which the electric potential applying portion 150 is configured to include a high-level potential applying portion 152H, a low-level potential applying portion 152L, a plurality of switching elements 162, and a plurality of switching elements 164 is illustrated. Even though the switching elements 162 and 164 are schematically illustrated, the switching elements 162 and 164 may be formed by using transistors, for example. In addition, the plurality of switching elements 162 may be formed by using the same driver as the gate driver 132, and the plurality of switching elements 164 may also be formed by using the same driver as the gate driver 132. In addition, a state of each of the switching elements 162 and 164 is not limited to the example shown in the drawing.

The high-level potential applying portion 152H includes a wiring line 154H, and the wiring line 154H is connected to an output end for high level potential of the driving IC 134. The low-level potential applying portion 152L includes a wiring line 154L, and the wiring line 154L is connected to an output end for low level potential of the driving IC 134.

Both the wiring lines 154H and 154L extend from the output ends to a one end side of the holding capacitance lines HL in the arrangement direction of the holding capacitance lines HL (direction corresponding to the column direction in the display region 52), pass through a side opposite the driving IC 134, and extends to the other end side of the holding capacitance lines HL in the arrangement direction of the holding capacitance lines HL. In addition, the arrangement positions of the wiring lines 154H and 154L are not limited to the example shown in the drawing.

At the one end side of the holding capacitance lines HL, each of the wiring lines 154H and 154L is connected to an end of each of the holding capacitance lines HL through each switching element 162. The switching element 162 is provided on each of the holding capacitance lines HL such that any one of the wiring lines 154H and 154L is selectively connected to each of the holding capacitance lines HL. Moreover, at the other end side of the holding capacitance lines HL, each of the wiring lines 154H and 154L is connected to the other end of each of the holding capacitance lines HL through each switching element 162. The switching element 164 is provided on each of the holding capacitance lines HL such that any one of the wiring lines 154H and 154L is selectively connected to each of the holding capacitance lines HL. That is, each of the holding capacitance lines HL is connected to the electric potential applying portion 150 at both ends of the holding capacitance line HL.

The switching elements 162 and 164 connected to the same holding capacitance line HL are controlled such that both the switching elements 162 and 164 select one of the high-level potential applying portion 152H and the low-level potential applying portion 152L. In other words, the switching elements 162 and 164 connected to the same holding capacitance line HL are controlled so as not to be connected to different potential applying portions 152H and 152L.

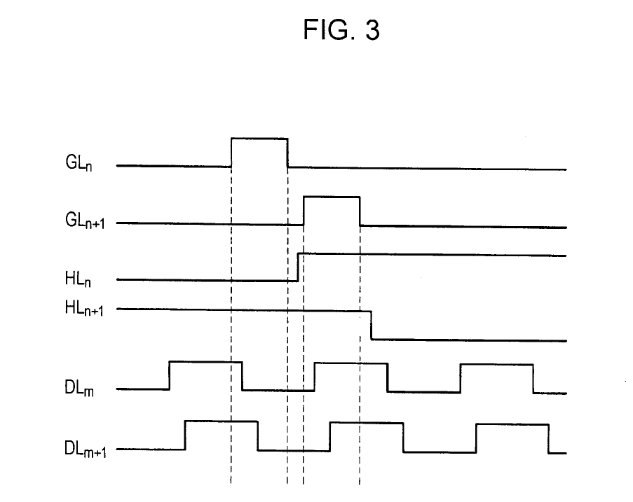

FIG. 3 is a timing chart explaining a driving method in the liquid crystal display device 50. In FIG. 3, examples of waveforms of electric potentials applied to the gate lines GLₙ and GLₙ₊₁, the holding capacitance lines HLₙ and HLₙ₊₁, and the data lines DLₘ and DLₘ₊₁ are shown. In addition, the electric potential VCOM (refer to FIG. 2) applied to the counter electrode may be a direct current (DC) or an alternating current (AC).

The electric potentials of the gate lines GLₙ and GLₙ₊₁ sequentially transition to a high level. During a period for which the gate line GLₙ is in a high level, an electric potential of display data of a corresponding pixel electrode is applied to the data lines DLₘ and DLₘ₊₁. Using a signal of the gate line GLₙ as a trigger, the electric potential of the holding capacitance line HLₙ is inverted after the electric potential of the gate line GLₙ has changed from a high level to a low level. That is, the holding capacitance line HLₙ is AC driven in a frame period. Then, the gate line GLₙ₊₁ is selected, such that the electric potential is applied to each of the wiring lines DLₘ, DLₘ₊₁, and HLₙ₊₁ in the same manner as described above. In FIG. 3, a case in which the holding capacitance lines HLₙ and HLₙ₊₁ adjacent to each other have opposite electric potentials is illustrated.

According to the configuration described above, a load of the holding capacitance line HL holding capacitance line HL is reduced compared with the configuration in which application of an electric potential to the holding capacitance line HL is performed only at a single side of the wiring line HL. As a result, the application of the electric potential to the holding capacitance line HL can be stably performed.

Due to the stable application of an electric potential to the holding capacitance line HL, it is possible to suppress crosstalk, for example. That is, in the driving method described above, the pixel transistors TR is turned off at a point of time when a potential level of the holding capacitance line HL is inverted. Accordingly, the electric potential of a pixel electrode that is in a floating state is changed with inversion of the potential level of the holding capacitance line HL. At this time, since the electric potential of each holding capacitance line HL is stabilized, that is, noise resistance of the holding capacitance line HL is improved, a change in electric potential of a pixel electrode is equal in each display line. As a result, the crosstalk can be suppressed.

The wiring lines 154H and 154L may also be disposed like a liquid crystal display device 50B, which will be described below.

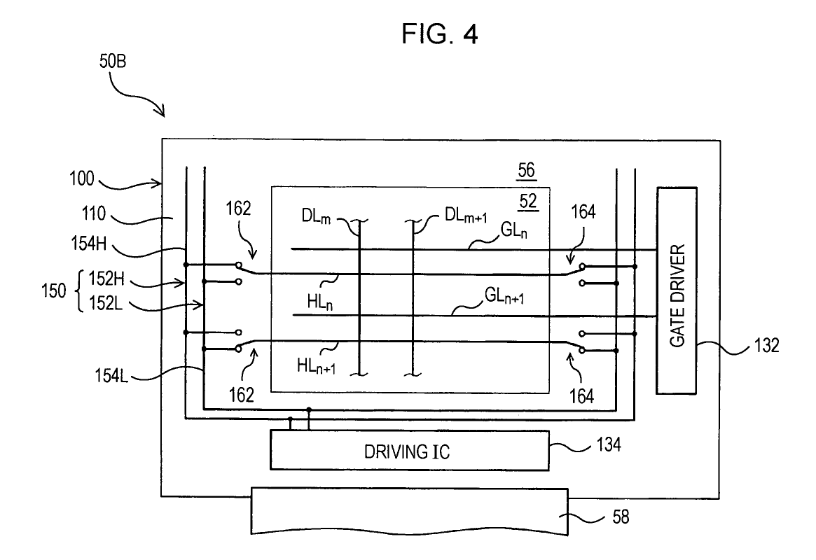

FIG. 4 is a plan view schematically explaining the liquid crystal display device 50B. The configuration of the liquid crystal display device 50 may be applied as that of the liquid crystal display device 50B except for the arrangement of the wiring lines 154H and 154L. In the liquid crystal display device 50B, each of the wiring lines 154H and 154L branches off in a region between the display region 52 and the driving IC 134 and extends to the one end side and the other end side of the holding capacitance line HL. Thus, the wiring lines 154H and 154L do not pass through a region opposite the driving IC 134.

Even in the liquid crystal display device 50B, the application of an electric potential to the holding capacitance line HL can be stably performed.

Here, the liquid crystal display devices 50 and 50B are compared. Many wiring lines, which are connected to output ends of the IC 134, are arranged near the driving IC 134. For this reason, it is preferable to cause the wiring lines 154H and 154L to make a detour to a side opposite the driving IC 134 by providing output ends of the driving IC 134 for the wiring lines 154H and 154L near an end of the driving IC 134, in the same manner as in the liquid crystal display device 50. According to those described above, it is avoided that the wiring lines 154H and 154L intersect other wiring lines and it is possible to prevent a noise occurring due to the intersection of wiring lines.

In addition, an electric potential applying portion 170 that is described below may also be applied instead of the electric potential applying portion 150.

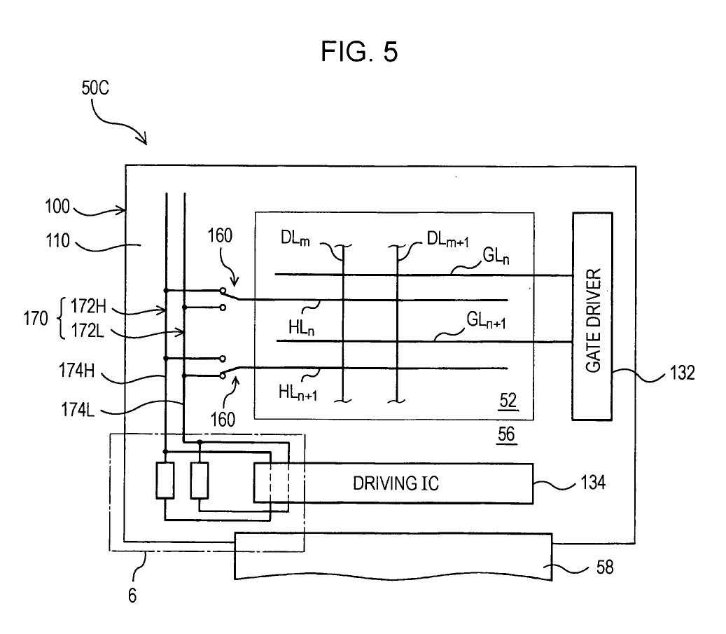

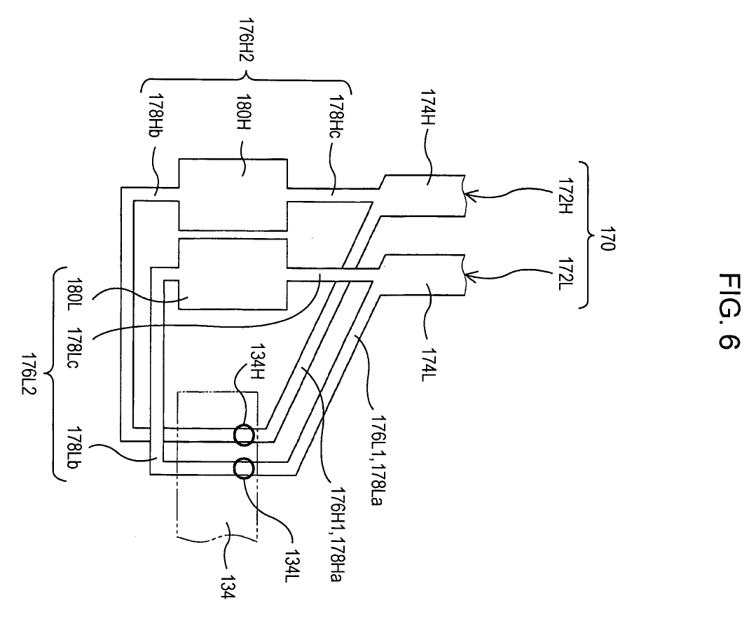

FIG. 5 is a plan view schematically explaining a liquid crystal display device 50C in which the electric potential applying portion 170 is applied. FIG. 6 is an enlarged plan view illustrating a portion 6 surrounded by a dashed-dotted line shown in FIG. 5. The configuration of the liquid crystal display device 50 may be applied as that of the liquid crystal display device 50C except for the electric potential applying portion 170.

The electric potential applying portion 170 is connected to the driving IC 134 and all of the holding capacitance lines HL. Moreover, in FIG. 6, the driving IC 134 is shown in a dashed-dotted line. Here, a case in which the electric potential applying portion 170 is configured to include a high-level potential applying portion 172H, a low-level potential applying portion 172L, and a plurality of switching elements 160 is illustrated.

The high-level potential applying portion 172H includes a wiring line 174H and two electric potential applying paths 176H1 and 176H2. The low-level potential applying portion 172L includes a wiring line 174L and two electric potential applying paths 176L1 and 176L2.

The wiring lines 174H and 174L extend in the arrangement direction of the wiring lines HL at the one end side of the holding capacitance line HL. In addition, the arrangement positions of the wiring lines 174H and 174L are not limited to the example shown in the drawing. At the one end side of the holding capacitance lines HL, each of the wiring lines 174H and 174L is connected to an end of each of the holding capacitance lines HL through the switching element 160. The switching element 160 is provided on each of the holding capacitance lines HL such that any one of the wiring lines 174H and 174L is selectively connected to each of the holding capacitance lines HL. Even though the switching element 160 is schematically shown in the drawing, the switching element 160 may be configured in the same manner as the switching elements. In addition, a state of each switching element 160 is not limited to the example shown in the drawing.

The two electric potential applying paths 176H1 and 176H2 are connected in parallel to each other and are connected to the wiring line 174H. That is, the high-level potential applying portion 172H has the two electric potential applying paths 176H1 and 176H2, which are connected in parallel to each other, provided in a part thereof.

The electric potential applying path 176H1 may be configured by using a wiring line 178Ha, for example. The wiring line 178Ha connects an end of the wiring line 174H close to the driving IC 134 with an output end 134H of the driving IC 134 for a high-level potential. Furthermore, in FIG. 6, the output end 134H is schematically shown in a circle.

The other electric potential applying path 176H2 may be configured by using a wiring line 178Hb, a test pad 180H, and a wiring line 178Hc, for example. The wiring line 178Hb connects the output end 134H of the driving IC 134 with the test pad 180H. The wiring line 178Hc connects the test pad 180H with the end of the wiring line 174H.

In addition, the two electric potential applying paths 176L1 and 176L2 are connected in parallel to each other and are connected to the wiring line 174L. That is, the low-level potential applying portion 172L has the two electric potential applying paths 176L1 and 176L2, which are connected in parallel to each other, provided in a part thereof.

The electric potential applying path 176L1 may be configured by using a wiring line 178La, for example. The wiring line 178La connects an end of the wiring line 174L close to the driving IC 134 with an output end 134L of the driving IC 134 for a low-level potential. Furthermore, in FIG. 6, the output end 134L is schematically shown in a circle.

The other electric potential applying path 176L2 may be configured by using a wiring line 178Lb, a test pad 180L, and a wiring line 178Lc, for example. The wiring line 178Lb connects the output end 134L of the driving IC 134 with the test pad 180L. The wiring line 178Lc connects the test pad 180L with the end of the wiring line 174L.

The test pads 180H and 180L are used to test the wiring lines 174H and 174L and the holding capacitance line HL. In addition, even though the test pads 180H and 180L are arranged on extending lines of the corresponding wiring lines 174H and 174L in the example shown in FIG. 6, the arrangement positions of the test pads 180H and 180L are not limited to the example.

In the example shown in FIG. 6, the wiring lines 178Hb and 178Lb pass below the driving IC 134 and reach the corresponding test pads 180H and 180L. Places where the wiring lines 178Hb and 178Hc are connected to the test pad 180H and places where the wiring lines 178Lb and 178Lc are connected to the test pad 180L are not limited to the example shown in FIG. 6. In addition, even though the wiring lines 178Ha, 178Hb, 178Hc, 178La, 178Lb, and 178Lc are shown in the shape of straight lines in FIG. 6, the wiring lines 178Ha, 178Hb, 178Hc, 178La, 178Lb, and 178Lc may be formed locally in a zigzag manner, for example.

Various kinds of wiring lines are disposed near the driving IC 134. For this reason, a case in which it is necessary to make the wiring line 178Ha thinner than the wiring line 174H may occur. However, since the electric potential applying path 176H2 is connected in parallel to the electric potential applying path 176H1 according to the configuration described above, a resistance of a path from the output end 134H of the driving IC 134 to the wiring line 174H is reduced compared with a configuration in which only the electric potential applying path 176H1 is used. In addition, the same is true for a path from the output end 134L of the driving IC 134 to the wiring line 174L. That is, a resistance of the electric potential applying portion 170 is reduced and application of an electric potential to the holding capacitance line HL can be stably performed. As a result, for example, the crosstalk can be suppressed. In addition, two or more electric potential applying paths may be connected in parallel to each other.

Here, the test pads 180H and 180L are formed such that the widths of the test pads 180H and 180L are larger than those of the wiring lines 178Hb, 178Hc, 178Lb, and 178Lc, since the test pads 180H and 180L need to be in contact with a test probe and the like. Accordingly, the electric potential applying paths 176H2 and 176L2 passing through the test pads 180H and 180L can be formed to have a lower resistance than the electric potential applying paths 176H1 and 176L1. For example, a resistance of each of the electric potential applying paths 176H2 and 176L2 may be 60Ω even in a case in which a resistance of each of the electric potential applying paths 176H1 and 176L1 is 160Ω. In the case of the numerical example, a resistance of each path from the driving IC 134 to each of the wiring lines 174H and 174L is reduced to about 40Ω.

Furthermore, according to the configuration described above, it is possible not only to use the test pads 180H and 180L in order to test wiring lines but also to effectively use the test pads 180H and 180L in order to form the electric potential applying paths 176H2 and 176L2. In addition, in the case when the test pads 180H and 180L are not used, it is necessary to reduce the resistances of the electric potential applying paths 176H2 and 176L2 by making the widths of wiring lines large. As a result, the peripheral region 56 (refer to FIG. 5) is increased. On the other hand, the increase in the peripheral region 56 can be suppressed by forming the electric potential applying paths 176H2 and 176L2 using the test pads 180H and 180L.

Even though the wiring line 178Hc is connected to an end of the wiring line 174H in the above description, the wiring line 178Hc may be connected to the middle of the wiring line 178Ha. Here, from the point of view of a decrease in resistance between the driving IC 134 and the wiring line 174H, it is preferable that the wiring lines 178Ha and 178Hc be connected to each other at ends thereof and be connected to the wiring line 174H, as described above. The same is true for the low-level potential applying portion 172L.

In addition, the electric potential applying portions 150 and 170 may be configured in combination with each other.

Furthermore, in the above description, the configuration in which the electric potential applying portion 150 includes the high-level potential applying portion 152H and the low-level potential applying portion 152L has been exemplified. However, in the case when a constant electric potential is applied to the holding capacitance line HL, the electric potential applying portion 150 may be configured not to include one of the potential applying portions 152H and 152L and one of the switching elements 162 and 164. Furthermore, in the case when an electric potential having three or more kinds of levels is used, the same configuration as the potential applying portion 152H or 152L may be added to the electric potential applying portion. The same is true for the electric potential applying portion 170.

In addition, even though the case in which the liquid crystal display device 50 is of a TN mode has been illustrated in the above description, the above configuration of the liquid crystal display device 50 may also be applied to the other modes, such as an IPS (in-plane switching) mode. In addition, the above configuration of the liquid crystal display device 50 may also be applied to electro-optical devices other than the liquid crystal display device, for example, a display device using electrophoresis.

What is claimed is:

1. An electro-optical device comprising:
a holding capacitor provided in each pixel;
a holding capacitance line connected to the holding capacitor; and
an electric potential applying portion that applies an electric potential to the holding capacitance line,
wherein both ends of the holding capacitance line are connected to the electric potential applying portion.

2. An electro-optical device comprising:
a holding capacitor provided in each pixel;
a holding capacitance line connected to the holding capacitor; and
an electric potential applying portion that applies an electric potential to the holding capacitance line,
wherein the electric potential applying portion has a plurality of electric potential applying paths provided in a part thereof, the plurality of electric potential applying paths being connected in parallel to each other.

3. The electro-optical device according to claim 2,
wherein the plurality of electric potential applying paths include a path passing through a test pad.

4. The electro-optical device according to claim 2,
wherein both the ends of the holding capacitance line are connected to the electric potential applying portion.

5. A substrate for an electro-optical device comprising:
a holding capacitor provided in each pixel;
a holding capacitance line connected to the holding capacitor; and
an electric potential applying portion that applies an electric potential to the holding capacitance line,
wherein both ends of the holding capacitance line are connected to the electric potential applying portion.

6. A substrate for an electro-optical device comprising:
a holding capacitor provided in each pixel;
a holding capacitance line connected to the holding capacitor; and
an electric potential applying portion that applies an electric potential to the holding capacitance line,
wherein the electric potential applying portion has a plurality of electric potential applying paths provided in a part thereof, the plurality of electric potential applying paths being connected in parallel to each other.

7. The electro-optical device according to claim 1, further comprising:
a pixel electrode provided in each pixel;
a pixel transistor connected to the pixel electrode;
a gate line and a data line connected to the pixel transistor; and
a driving circuit that outputs an electric potential applied to the gate line, the data line, and the electric potential applying portion,
wherein the driving circuit sequentially applies a high-level electric potential to the gate lines, applies an electric potential of display data to the data line during a period for which the gate line is in a high level to thereby apply the electric potential of the display data to the pixel electrode, and inverts the electric potential applied to the electric potential applying portion after the electric potential of the gate line has changed from a high level to a low level.
